(19) United States
(12) Patent Application Publication
(10) Pub. No.: US 2026/0205212 A1
(43) Pub. Date: Jul. 16, 2026

(54) DEVICES, METHODS, APPARATUSES AND COMPUTER READABLE MEDIUM FOR COMMUNICATIONS

(71) Applicant: Nokia Solutions and Networks Oy, Espoo (FI)

(72) Inventors: Xin Miao Li, Zhejiang (CN); Wei Chen, Zhejiang (CN); Qi Zhang, Zhejiang (CN); Xianhua He, Zhejiang (CN); Tianyang Qi, Zhejiang (CN); Jun Ma, Zhejiang (CN); Juemin Liu, Zhejiang (CN)

(21) Appl. No.: 19/135,482

(22) PCT Filed: Dec. 5, 2022
(86) PCT No.: PCT/CN2022/136523

§ 371 Date: Jun. 4, 2025

(51) Int. Cl. H04B 17/318; G06N 5/01; H04L 41/16; H04W 24/02

(52) U.S. Cl. CPC H04B 17/328; G06N 5/01; H04L 41/16; H04W 24/02

(57) ABSTRACT

Embodiments of the present disclosure disclose devices, methods and apparatuses for communications. In the embodiments, a network device receives at least one of reference signal received power (RSRP) and reference signal received quality (RSRQ) associated with a serving cell of a terminal device from the terminal device. Then, the network device determines, based on the at least one of the RSRP and the RSRQ associated with the serving cell, a signal quality level associated the neighboring cell of the serving cell using a machine learning (ML) or artificial intelligence (AI) model. In this way, the throughput of the communication system can be improved.

### FIELD

Embodiments of the present disclosure generally relate to the field of telecommunication, and in particular, to devices, methods, apparatuses and computer readable storage medium for communications.

### BACKGROUND

With the development of communication technology, a terminal device is enabled to operate on one or more frequency carriers or frequency bands. In turn, for enhancing the coverage of cells, one or more network devices may provide a plurality of cells, and each of the plurality of cells corresponds to a respective frequency carrier and/or a respective radio access technology (RAT). In an example, a cell having a higher frequency carrier may be configured with a wider bandwidth, in order to improve the traffic throughput for the terminal device camped in this cell. In another hand, another cell having a lower frequency carrier may have a coverage area larger than that of the cell having the higher frequency carrier, in order to provide seamless coverage for the terminal device.

In some cases, the terminal device is required to measure neighboring cells during performing communication traffic with the serving cell, and the terminal device further transmits the measurement report of the neighboring cell to the network device. Then, the network device may schedule the terminal device accordingly, for example, handover or other cell-level operations. Accordingly, the improvement in estimating the quality of the cells associated with the terminal device is a key aspect related to communication performance.

### SUMMARY

In general, example embodiments of the present disclosure provide devices, methods, apparatuses and computer readable storage medium for estimating neighboring cells.

In a first aspect, there is provided a network device. The network device may comprise at least one processor; and at least one memory storing instructions that, when executed by the at least one processor, cause the network device to: receive, from a terminal device, at least one of reference signal received power (RSRP) and reference signal received quality (RSRQ) associated with a serving cell of the terminal device. The network device is further caused to determine, based on the at least one of the RSRP and the RSRQ associated with the serving cell, a signal quality level associated the neighboring cell of the serving cell using a machine learning (ML) or artificial intelligence (AI) model.

In a second aspect, there is provided a terminal device. The terminal device may comprise at least one processor; and at least one memory storing instructions that, when executed by the at least one processor, cause the terminal device to: transmit at least one of RSRP and RSRQ associated with a serving cell of the terminal device to a network device, and the at least one of the RSRP and the RSRQ associated with the serving cell being to be used for determining a signal quality level associated the neighboring cell of the serving cell based on a ML or AI model.

In a third aspect, there is provided a method implemented at a network device. The method comprises: receiving at least one of RSRP and RSRQ associated with a serving cell of a terminal device from the terminal device; and determining, based on the at least one of the RSRP and the RSRQ associated with the serving cell, a signal quality level associated with a neighboring cell of the serving cell using a ML or AI model.

In a fourth aspect, there is provided a method implemented at a terminal device. The method comprises: transmitting at least one of RSRP and RSRQ of a serving cell of the terminal device to a network device, and the at least one of the RSRP and the RSRQ of the serving cell being to be used for determining a signal quality level of a neighboring cell of the serving cell based on a ML or AI model.

In a fifth aspect, there is provided an apparatus of a network device. The apparatus comprises: means for receiving at least one of RSRP and RSRQ associated with a serving cell of the terminal device from a terminal device; and means for determining, based on the at least one of the RSRP and the RSRQ associated with the serving cell, a signal quality level associated with a neighboring cell of the serving cell using a ML or AI model.

In a sixth aspect, there is provided an apparatus of a terminal device. The apparatus comprises: means for transmitting at least one of RSRP and RSRQ of a serving cell of the terminal device to a network device, and the at least one of the RSRP and the RSRQ of the serving cell being to be used for determining a signal quality level of a neighboring cell of the serving cell based on a ML or AI model.

In a seventh aspect, there is provided a non-transitory computer readable medium comprising program instructions for causing an apparatus to perform at least the method according to any of third to fourth aspects.

In an eighth aspect, there is provided a computer program comprising instructions, which, when executed by an apparatus, cause the apparatus at least to: receive, from a terminal device, at least one of RSRP and RSRQ associated with a serving cell of the terminal device; and determine, based on the at least one of the RSRP and the RSRQ associated with the serving cell, a signal quality level associated the neighboring cell of the serving cell using a ML or AI model.

In a ninth aspect, there is provided a computer program comprising instructions, which, when executed by an apparatus, cause the apparatus at least to: transmit, to a network device, at least one of RSRP and RSRQ associated with a serving cell of the terminal device, the at least one of the RSRP and the RSRQ associated with the serving cell being to be used for determining a signal quality level associated the neighboring cell of the serving cell based on a ML or AI model.

In a tenth aspect, there is provided a network device. The network device comprises receiving circuitry configured to: receive at least one of RSRP and RSRQ associated with a serving cell of a terminal device from the terminal device. The network device further comprises determining circuitry configured to: determine, based on the at least one of the RSRP and the RSRQ associated with the serving cell, a signal quality level associated the neighboring cell of the serving cell using a ML or AI model.

In an eleventh aspect, there is provided a terminal device. The terminal device comprises transmitting circuitry configured to: transmit, to a network device, at least one of RSRP and RSRQ associated with a serving cell of the terminal device, the at least one of the RSRP and the RSRQ associated with the serving cell being to be used for determining a signal quality level associated with a neighboring cell of the serving cell based on a ML or AI model.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example network environment in which example embodiments of the present disclosure may be implemented;

FIG. 1B illustrates an example measurement gap for an inter-frequency and inter-radio access technology (RAT) measurement;

FIG. 2 illustrates an example signaling process for estimating the quality of neighboring cells according to some embodiments of the present disclosure;

FIG. 3A illustrates an example path loss of a reference signal transmitted from the network device according to some embodiments of the present disclosure;

FIG. 3B illustrates an example direction of arrival (DOA) of the signal transmitted from the terminal device to the network device according to some embodiments of the present disclosure;

FIG. 4A illustrates example estimation results corresponding to different input parameters of the machine learning (ML) or artificial intelligence (AI) model according to some embodiments of the present disclosure;

FIG. 4B illustrates example estimation results corresponding to different output parameters of the machine learning (ML) or artificial intelligence (AI) model according to some embodiments of the present disclosure;

FIG. 4C illustrates example comparison between estimation result and actual result according to some embodiments of the present disclosure;

FIG. 5A illustrates example estimation results corresponding to different machine learning (ML) or artificial intelligence (AI) models according to some embodiments of the present disclosure;

FIG. 5B illustrates example operation costs corresponding to different machine learning (ML) or artificial intelligence (AI) models according to some embodiments of the present disclosure;

FIG. 5C illustrates an example Extra Trees Regression model according to some embodiments of the present disclosure;

FIG. 5D illustrates an example of reconstructed Extra Trees Regression model according to some embodiments of the present disclosure;

FIG. 6A illustrates an example comparison between the estimation result of the Extra Trees Regression model and the estimation result of the reconstructed Extra Trees Regression model according to some embodiments of the present disclosure;

FIG. 6B-FIG. 6E illustrate the gain of cell average throughput and resource block utilization according to some embodiments of the present disclosure;

FIG. 7 illustrates flowchart of a method implemented at a terminal device according to example embodiments of the present disclosure;

FIG. 8 illustrates an example flowchart of a method implemented at a network device according to example embodiments of the present disclosure;

FIG. 9 illustrates an example simplified block diagram of an apparatus that is suitable for implementing embodiments of the present disclosure; and

FIG. 10 illustrates an example block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, 5G-A, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As mentioned above, the improvement in estimating quality of the cells associated with the terminal device is a key aspect related to communication performance. The communication systems operate on an increasing number of higher frequency bands. Without any limitation, in the 5G system, a high frequency band may require a larger number of base stations to provide coverage. The network cells become denser and denser and the frequency bands become more and more accordingly. For a multi-frequency network, while performing communication with the serving cell, a terminal device can easily measure the signal associated with the other cells that is transmitted on the same frequency as the serving cell. However, when performing communication with the serving cell, the terminal device cannot perform the measurement on the other cells configured with a carrier frequency or a RAT different from the serving cell. Even for intra-frequency measurements, a terminal device in the 5G system also cannot perform measurements outside the current active Bandwidth Part (BWP) for the terminal device.

For measuring neighboring cells that operate at a carrier frequency different from the serving cell (which may be also referred to as inter-frequency measurement) and/or operate at RAT different from the serving cell (which may be also referred to as inter-RAT measurement), the communication traffic between the terminal device and the serving cell has to be suspended. The time duration during which the terminal device suspends the communication traffic with the serving cell and performs inter-frequency or inter-RAT measurement is known as Measurement Gap, which is defined in 3GPP specification. In addition, the terminal device transmits the measurement report of the inter-frequency or inter-RAT measurement to a corresponding network device. In other words, the terminal device is required to suspend communication traffic with the serving cell, in order to perform the inter-frequency measurement and/or the inter-RAT measurement. As such, the terminal device may consume additional power and resources for the inter-frequency measurement and/or the inter-RAT measurement.

In view of the above and in order to improve the performance of a communication system, a scheme for estimating neighboring cells is provided. In this scheme, a network device receives at least one of reference signal received power (RSRP) and reference signal received quality (RSRQ) associated with a serving cell of the terminal device from a terminal device. Then, based on the at least one of the RSRP and the RSRQ associated with the serving cell, the network device determines a signal quality level associated with a neighboring cell of the serving cell using a machine learning (ML) or artificial intelligence (AI) model. In this case, the network device may directly determine the quality of the neighboring cell without necessarily receiving the measurement report of the neighboring cell from the terminal device. In turn, the terminal device can omit the steps of the measurement on the neighboring cells and the transmission of the measurement report.

In this way, only based on the RSRP and RSRQ associated with the serving cell, the signal quality level associated with the neighboring cell can be determined exactly at the network device. As such, the terminal device is not required to perform inter-frequency and/or inter-RAT measurement and the measurement power and report resources can be saved accordingly.

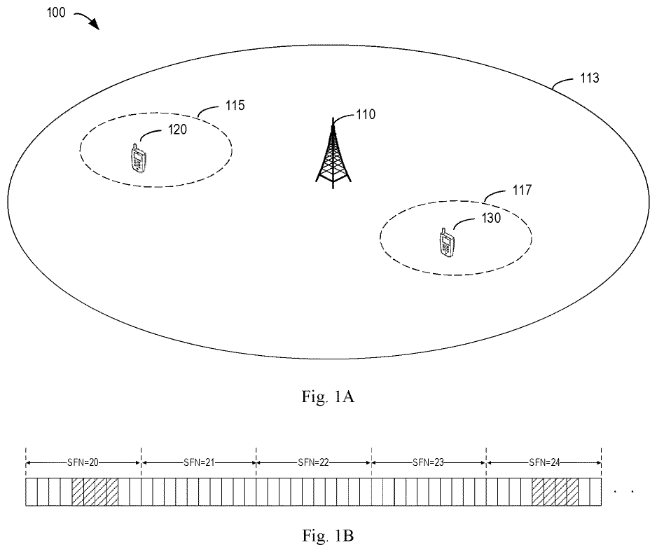

Principle and embodiments of the present disclosure will be described in detail below with reference to the accompanying drawings. FIG. 1A illustrates an example network environment 100 in which example embodiments of the present disclosure may be implemented. The environment 100, which may be a part of a communication network, includes terminal devices and network devices.

As illustrated in FIG. 1A, the network environment 100 may include a network device 110, a terminal device 120 and another terminal device 130. Without any limitation, the network device 110 may provide a plurality of cells which each may have a corresponding carrier frequency or RAT. Only for the purpose of illustration and without any limitation, in the example shown in FIG. 1, the cell 113 provided by the network device 110 may have a lower carrier and a larger coverage area. In turn, the cells 115 and 117 provided by the network device 110 may have a higher carrier frequency, in order to enhance the traffic throughout with the terminal devices 120 and 130. In addition, the cell 115 may be configured with a RAT different form the RAT configured for the cell 117. As mentioned above, the terminal device 120 may suspend communication with the serving cell 115 and measure signals transmitted from neighboring cells, for example, the cell 113 or the cell 117.

It is to be understood that the number of network devices and terminal devices is given only for the purpose of illustration without suggesting any limitations. The system 100 may include any suitable number of network devices and/or terminal devices adapted for implementing embodiments of the present disclosure. Although not shown, it would be appreciated that one or more terminal devices may be located in the environment 100.

Communications in the network environment 100 may be implemented according to any proper communication protocol(s), comprising, but not limited to, the third generation (3G), the fourth generation (4G), the fifth generation (5G), 5G-Advanced or beyond (6G), wireless local network communication protocols such as institute for electrical and electronics engineers (IEEE) 802.11 and the like, and/or any other protocols currently known or to be developed in the future. Moreover, the communication may utilize any proper wireless communication technology, comprising but not limited to: multiple-input multiple-output (MIMO), orthogonal frequency division multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), carrier aggregation (CA), dual connectivity (DC), and new radio unlicensed (NR-U) technologies.

FIG. 1B illustrates an example measurement gap for an inter-frequency and inter-radio access technology (RAT) measurement.

As mentioned above, the measurement gaps are opportunities given to the terminal device for performing measurements on downlink signals, in order to obtain the inter-frequency or inter-RAT measurements. Further, a measurement gap repetition period defines the period of measurement gap repetitions. In some embodiments, the measurement gap repetition period may be configured. For example, in the 3GPP specification, the gap repetition period may be configured as 20, 40, 80, and 160 ms. The example in FIG. 1B shows a measurement gap within sub-frames #4, #5, #6 and #7, the measurement gap repetition period is 40 ms, and sub-frames #4, #5, #6 and #7 have the sub-frame number (SFN) 20, 21, 22 and 23, respectively. FIG. 1B further shows another subsequent measurement gap in the sub-frame #8 having the SFN 24. The time interval between the measurement gap and the subsequent measurement gap equals to the configured measurement gap repetition period.

As such, the less measurement gap repetition period leads more measurements, and therefore more dedicated time for performing measurements will be caused. During the measurement gaps, the terminal device cannot perform communication with the serving cell and average throughput is reduced accordingly. To reduce the costs of inter-frequency measurements, in this disclosure, a procedure of predicting the signal strength and quality of inter-frequency carrier and inter-RAT carrier is provided, and the procedure is only based on the measurements on the serving carrier. Simulations in real network deployment show that the prediction accuracies as high as 98.5%.

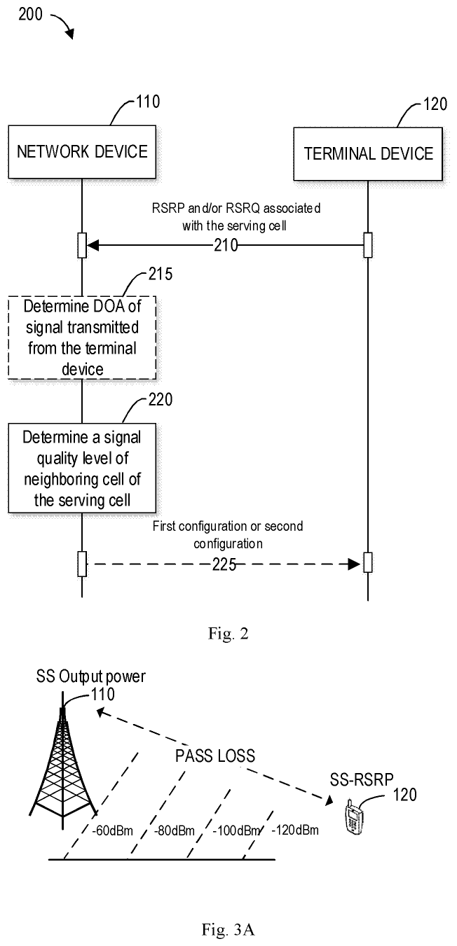

FIG. 2 illustrates an example signaling process 200 for estimating the quality of neighboring cells according to some embodiments of the present disclosure. For the purpose of discussion, the process 200 will be described with reference to FIG. 1A. It would be appreciated that although the process 200 has been described in the communication environment 100 of FIG. 1A, this process 200 may be likewise applied to other communication scenarios.

In the signaling process 200, the terminal device 120 (or the terminal device 130, without any limitation, the following embodiments are discussed with reference to the terminal device 120) transmits (210) at least one of RSRP and RSRQ associated with the serving cell 115 of the terminal device 120.

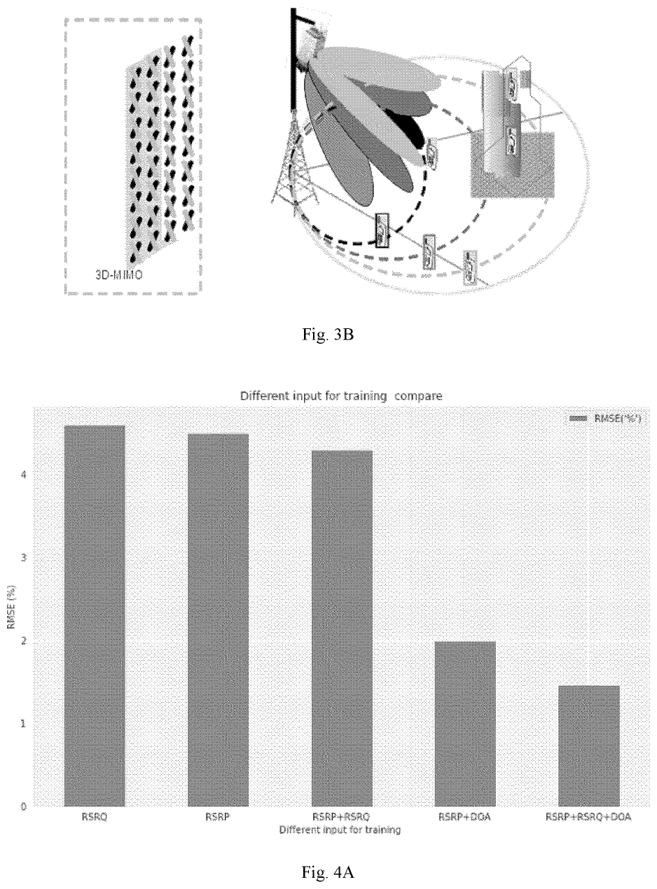

In some embodiments, the RSRP may be a Synchronization Signal Reference Signal Received Power (SS-RSRP). The SS-RSRP is the average power received from single resource elements that allocated to the synchronization signal reference signal as show in FIG. 3 (which may be further discussed in the following). The terminal devices (for example, the terminal devices 120 and 130) in a network are assumed to send SS-RSRP measurement reports to the network device. Without any limitation, the RSRP may be received power of any other reference signal, such as, de-modulation reference signal (DMRS), channel state information-reference signal (CSI-RS) and so on. In one solution, the SS-RSRP reports include the measurements of the serving cell and the other measurements of up to eight neighboring cells of the primary carrier of the serving cell. However, in this case, the terminal device 120 needs to perform measurements on the neighboring cells and report the measurement reports on the respective resources.

According to some embodiments in the disclosure, the terminal device 120 may only perform the measurements on the serving cell (which should be performed naturally, and this is the intra-frequency measurement or intra-BWP measurement) and transmit the measurement information on the serving cell (such as, the RSRP of the serving cell) to the network device 110. In addition, the terminal device 120 may perform no measurements on the other neighboring cells and transmitting the other measurement information on the other neighboring cells to the network device 110. In turn, the network device 110 may only receive the RSRP (and/or RSRQ) associated with the serving cell, without receiving the signal quality level associated with the neighboring cell of the serving cell. In this case, the measurement power and the corresponding uplink (UL) resources can be saved. For example, the gain of cell average throughput up to 30.7%, and there is almost no impact to other network key performance indicator (KPI) such as drop rate (DR) and handover scheduling request (HO SR).

In addition or alternatively, in some embodiments, the RSRQ may be a secondary synchronization Signal Reference Signal Received Quality (SS-RSRQ). In an example, SS-RSRQ is determined by:

$$SS - RSRQ = \frac{N * SS - RSRP}{R S S I}$$

where N is the number of resource blocks in the carrier measurement bandwidth, and RSSI is the reference signal strength indicator. The terminal devices in the network are assumed to send SS-RSRQ measurement reports. Without any limitation, the RSRQ may be received quality of any other reference signal, such as, de-modulation reference signal (DMRS), channel state information-reference signal (CSI-RS) and so on. In one solution, the SS-RSRQ measurement reports include the measurements of the serving cell and up to eight neighboring cells on the primary carrier. In this way, it is possible to compare the quality of signals from individual cells in networks. It is important feature for load balance, handover and secondary cell selection.

According to some embodiments in the disclosure, similarly, the terminal device 120 may only perform the RSRQ measurements on the serving cell (which should be performed naturally, and this is the intra-frequency measurement or intra-BWP measurement) and transmit the RSRQ measurement information on the serving cell (such as, the RSRQ of the serving cell), without performing the measurements on the other neighboring cells and transmitting the other measurement information on the other neighboring cells.

Referring back to FIG. 2, the network device 110 receives (210) the at least one of the RSRP and the RSRQ associated with the serving cell 115 from the terminal device 120. Then, the network device 110, based on the at least one of the RSRP and the RSRP, determines (220) the signal quality level associated with a neighboring cell of the serving cell 115 using an ML or AI model.

As such, the network device 110 may only use at least one of the RSRP and the RSRQ associated with the serving cell 115 as the input parameters for the used ML or AI model.

In addition, the network device 110 may determine the signal quality level associated with a neighboring cell further based on angle information of the terminal device 120. In one solution, the angle information may be determined from the precoding matrix indicator (PMI) information received from the terminal device 120. In this case, the angle information is determined by the terminal device 120, and the measurement accuracy at the terminal device may be poor. Further, the terminal device 120 may calculate the angle information by using additional resources. In turn, the additional power may be also consumed accordingly.

In some embodiments of the disclosure, the network device 110 may determine the signal quality level associated with a neighboring cell further based on the direction of arrival (DOA) of a signal transmitted from the terminal device 120 to the network device 110. In addition, the DOA is calculated at the network device 110. In this way, the measurement accuracy of the DOA may be at the level of 0.1 degree. Further, the calculation step of the angle information can be omitted at the terminal device 120, and the corresponding cost can be saved.

As such, the network device 110 may only use the DOA of the signal transmitted from the terminal device 120 and at least one of the RSRP and the RSRQ associated with the serving cell 115 as the input parameters for the used ML or AI model. Then, the network device 110 may determine the signal quality level associated with a neighboring cell by the output of the used ML or AI model. In some embodiments, the output of the ML or AI model may be at least one of RSRP or RSRQ associated with the neighboring cell. For example, the output may be RSRP of inter-frequency carriers and inter-RAT carriers, and/or RSRQ of inter-frequency carriers and inter-RAT carriers.

The network device 110 may only use such little input parameters to achieve a good performance (which may be shown in the following), since the input parameters may implicitly indicate the location of the terminal device within the serving cell. For purposes of illustration, the input parameters may be further discussed with reference to FIGS. 3A and 3B.

FIG. 3A illustrates an example path loss of a reference signal transmitted from the network device according to some embodiments of the present disclosure. As shown in FIG. 3A, the SS-RSRP at the terminal device 120 is related to the path loss between the network device 110 and the terminal device 120. Further, the path loss is related to the distance between the network device 110 and the terminal device 120.

FIG. 3B illustrates an example DOA of the signal transmitted from the terminal device to the network device according to some embodiments of the present disclosure. As shown in FIG. 3B, the DOA is the direction of the propagating wave arriving at the network device at where usually a set of antenna array are located. The DOA reflects the orientation of the terminal device. For example, with the beamforming technology, the network device may estimate a given direction of the signal both in horizontal direction and vertical direction. In this way, the above input parameters (the RSRP, RSRQ and/or DOA) may reflect the distance and orientation information of the terminal device within the serving cell 115. Therefore, the ML or AI model can exactly learn how to estimate the signal quality associated with the neighboring cell based on the carefully selected input parameters. In this way, the location of the terminal device 120 can be implicitly indicated or determined at the network device 110 without transmitting the dedicated location information by the terminal device 120. Moreover, the transmitted RSRP and RSRQ associated with the serving cell are transmitted by the terminal device 120 for other purposes, the RSRP and RSRQ are reused for estimating neighboring cells in this disclosure. As such, the terminal device is not required to perform extra operations for measuring the neighboring cells.

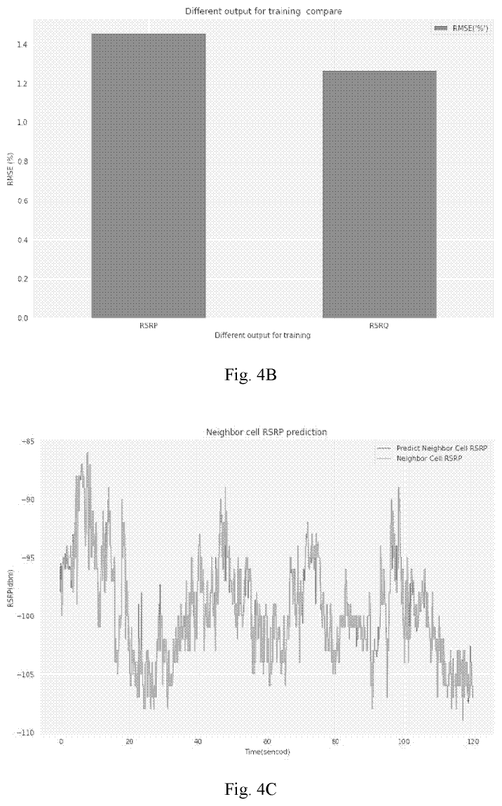

With respect to the different input parameters and different output parameters for the ML or AI model, FIG. 4A-FIG. 4C show corresponding estimation performance.

FIG. 4A illustrates example estimation results corresponding to different input parameters of the machine learning (ML) or artificial intelligence (AI) model according to some embodiments of the present disclosure. Different measurements associated with the serving cell may be used as the input parameters to predict the neighboring cell's RSRP and RSRQ. In addition, the estimation is performed on the ML or AI model that is the extra tree regression algorithm. As shown in FIG. 4A, adding DOA information as the input parameter may achieve better performance (lower RMSE) than the only using RSRP or RSRQ as the input parameter. RMSE (Root Mean Square Error) is used as metric for the accuracy of estimation or inference. RMSE is calculated by:

$$RMSE = \sqrt{\frac{1}{m} {\sum }_{i = 1}^{m} {( {y}_{i} - {\hat{y}}_{i} )}^{2}}$$

where yᵢ is the ith actual signal quality associated with the neighboring cell, and the ŷₗ is the corresponding predicting value.

In the simulations in FIG. 4A (which used the log from a gNodeB field test and get more than 26 thousands data samples, in which 23 thousands data samples are used for training the ML or AI model and three thousands data samples are used for the verification), using RSRP, RSRQ and DOA as input parameters may achieve the best performance. Specifically, the RMSE of predicting RSRP of Neighboring cells is lower than 1.5%, and RMSE of predicting RSRQ of Neighboring cell is around 1.3%.

FIG. 4B illustrates example estimation results corresponding to different output parameters of the machine learning (ML) or artificial intelligence (AI) model according to some embodiments of the present disclosure. As shown in FIG. 4B, the output having the RSRQ associated with the neighboring cell may achieve better performance.

In addition, FIG. 4C illustrates example comparison between estimation result and actual result according to some embodiments of the present disclosure. As shown in FIG. 4C, the predicted RSRP associated with the neighboring cell 115 can fit the actual RSRP measured by the terminal device perfectly. Specifically, the following table 1 further lists the handover numbers triggered based on the predicted RSRP and the actual RSRP respectively and the corresponding handover ratios.

TABLE 1

| | Previous art | This invention |
|---|---|---|
| Handover number | 615 | 602 |
| Total number | 25858 | 25856 |
| Handover ratio | 2.378% | 2.328% |

The total number in Table 1 is the total number of predicted RSRP values and the total number of the actual RSRP values. As listed in Table 1, the predicted RSRP almost has no impact to the HO SR of the terminal device 120 relative to the HO SR triggered by the actual RSRP measured by the terminal device 120.

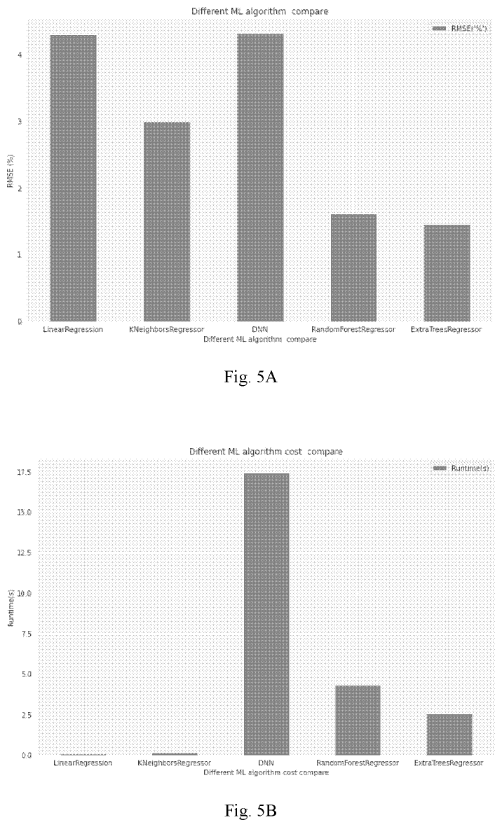

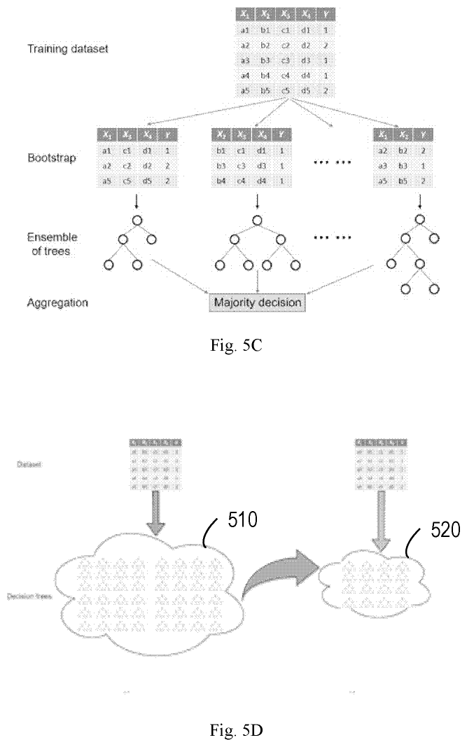

Still referring to FIG. 2, the network device 110 may employ any of the existing ML or AI models. Alternatively, the network device 110 may also employ the ML or AI models that will be designed, studied and constructed in the future. In an example, the ML or AI model may include one of: an extra tree regression model, a random forest regression model, a linear regression model, a KNeighborsRegressor model, or a deep neural network (DNN) model. For purposes of illustration, the variety of ML or AI models may be further discussed with reference to FIGS. 5A to 5D.

FIG. 5A illustrates example estimation results corresponding to different machine learning (ML) or artificial intelligence (AI) models according to some embodiments of the present disclosure.

As shown in FIG. 5A, the tree-based regression model or algorithm (for example, random forest regression model and extra trees regression model) has better performance than linear regression, KNeighbor regression and deep neural network (DNN) model or algorithm. Without any limitation, the ML or AI models in FIG. 5A are trained based on: the RSRP and RSRQ associated with the serving cell, and DOA of the terminal device that act as the input data samples, and RSRP associated with the neighboring cells that acts as the output of the model. In some embodiments, the ML or AI model may be trained based on historical data of at least one of RSRP and RSRQ measured by a plurality of terminal devices in respective serving cells. In addition, the ML or AI model may be trained further based on the DOA of the terminal devices. In the simulation, the DNN model has the worst performance, different approaches have been used to optimize Neural Network and hyper parameters within the DNN model but the performance improvement is limited.

In addition, FIG. 5B illustrates example operation costs corresponding to different machine learning (ML) or artificial intelligence (AI) models according to some embodiments of the present disclosure. As shown in the example of FIG. 5B, the operation cost or resource consumption of the DNN model and the operation cost or resource consumption of the LinearRegression model are higher than the that of other ML or AI models. Specifically, FIG. 5B actually shows the complexity (which may correspond to the runtime, operation cost or computing cost) of each ML or AI model. Extra Tree regression may require more computing cost than linear regression and neighbor algorithm. But the computing cost of Extra Tree regression still less than that of the random Forest regression and DNN model. In the simulation, the training runtime of Extra Tree regression is around 2.5 s.

As shown in FIGS. 5A and 5B, the tree-based regression model or algorithm can achieve better performance while having shorter runtime or using smaller computing costs.

Since the serving cell may have a plurality of different neighboring cells, and the RSRP and RSRQ associated with the neighboring cells at least partially depend on the cell deployment and radio environment, such that predicting the neighbor cell's RSRP and RSRQ is a complex nonlinear problem. Therefore, using tree-based regression model may achieve better performance as discussed above, the normalized RMSE of the tree-based regression models is about 1.47%.

As shown in the simulations of FIGS. 5A and 5B, the tree based regression model or algorithm may be a suitable ML or AI model for determining the signal quality level associated with the neighboring cells. The Extra Tree is a powerful alternative random forest ensemble approach, and it is a type of ensemble learning technique that aggregates the results of different de-correlated decision trees similar to Random Forest. In some cases, the Extra Tree model can achieve better performance than the typical random forest model. In some embodiments, the network device 110 may construct an extra tree regression model by training a plurality of trees based on a plurality of training data sets which may be further discussed with reference to FIG. 5C.

FIG. 5C illustrates an example Extra Trees Regression model according to some embodiments of the present disclosure.

As shown in FIG. 5C, the Extra Trees Regression model may split the training data to N (which is also the number of trees) sets of training data. In addition, for each set of training data, the Extra Trees Regression model is constructed by training a respective decision tree model. Then, the Extra Trees Regression model combines the decision trees to random forest. The average result of all decision trees' results is the output of the constructed Extra Trees Regression model. As shown in FIG. 5B, the runtime of the Extra Trees Regression model is about 2.5 s which is also too heavy for embedded system like gNB for on-line training. In some embodiments, the network device 110 may reconstruct the Extra Trees Regression model to reduce the runtime or the complexity of this model.

The above input parameters of the ML or AI model have a high typical and correlation. In this case, the structure of the Extra Trees Regression model may be reconstructed to reduce the complexity. In turn, the reconstructed Extra Trees Regression model may be used in the embedded system while only using limited computing resource.

The complexity of the Extra Trees Regression model is at the level of O(n²), where n is the number of trees within the Extra Trees Regression model. By modifying modeling parameters of the tree (decision tree) within the Extra Trees Regression model, especially the number of trees. For purposes of illustration, the reconstruction of the Extra Trees Regression model is discussed with reference to FIG. 5D.

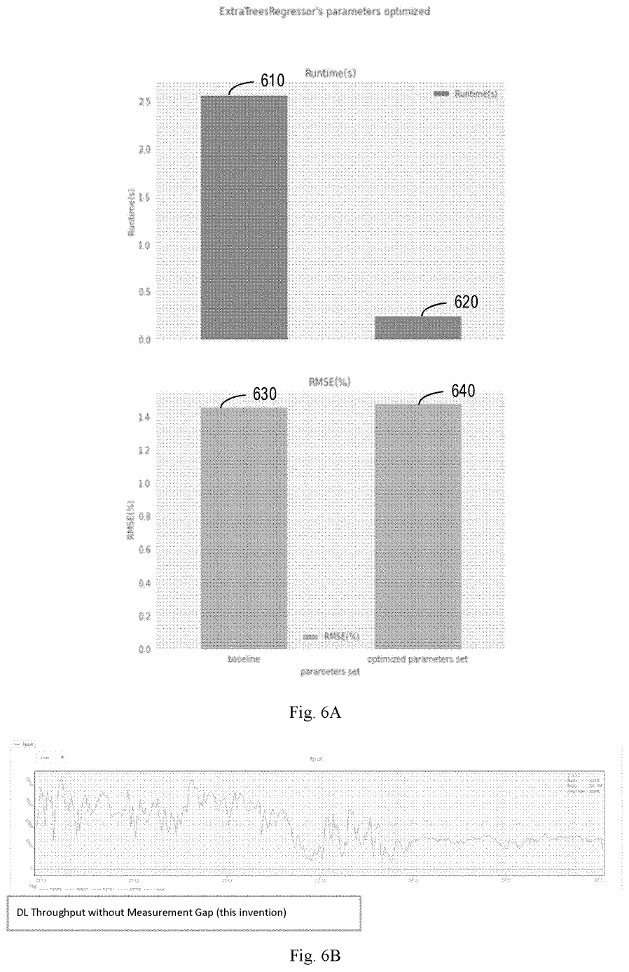

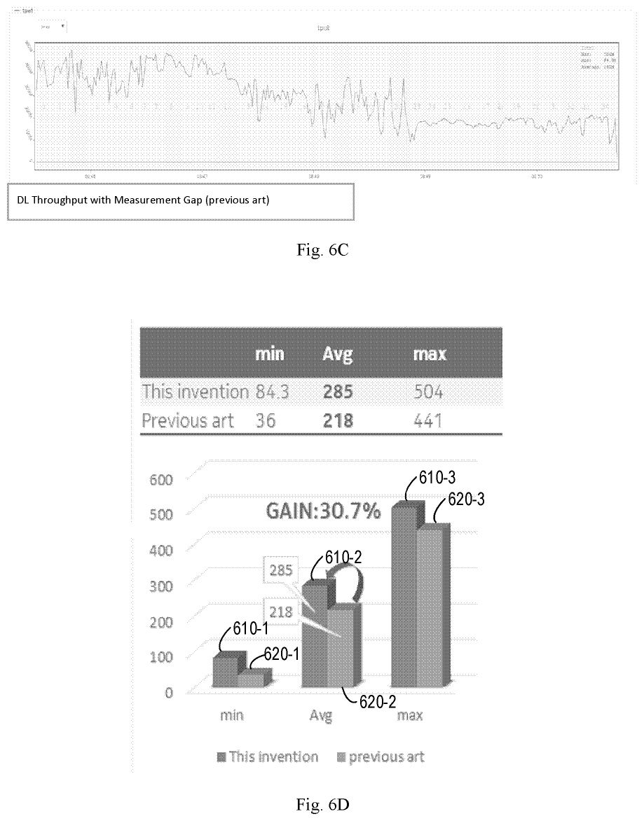

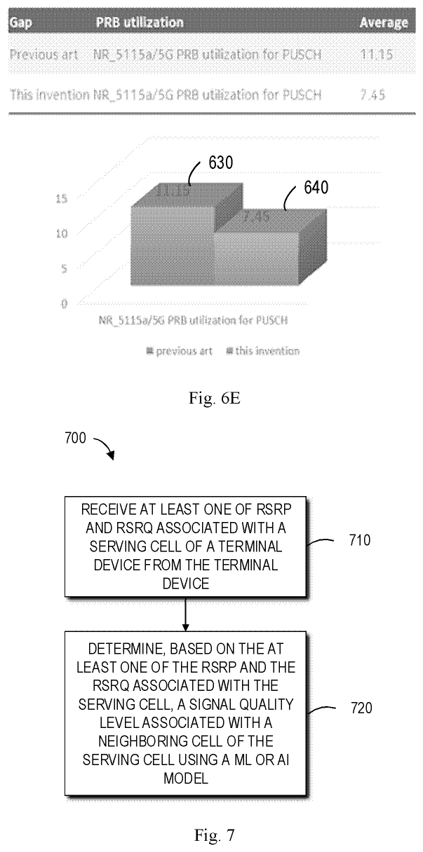

FIG. 5D illustrates an example of reconstructed Extra Trees Regression model according to some embodiments of the present disclosure. As shown in FIG. 5D, the network device 110 may reconstruct the extra tree regression model by reducing the number of the plurality of trees within the extra tree regression model. In the example shown in FIG. 5D, the first number of trees (510) within the Extra Trees Regression model may be reduced to the second number of trees (520) within the constructed Extra Trees Regression model. In addition, for purposes of illustration, the performance and the operation cost of the reconstructed Extra Trees Regression model are discussed with reference to FIGS. 6A-6E.

FIG. 6A illustrate an example comparison between the estimation result of the Extra Trees Regression model and the estimation result of the reconstructed Extra Trees Regression model according to some embodiments of the present disclosure.

As shown in FIG. 6A, the block 610 represents the runtime of the typical Extra Trees Regression model and the block 620 represents the runtime of the reconstructed Extra Trees Regression model. It can be seen that the runtime or complexity of the reconstructed Extra Trees Regression mode is significantly reduced. Specifically, about 90% of the complexity, runtime or computing cost is saved. Further, the block 630 represents the RMSE performance of the typical Extra Trees Regression model and the block 640 represents the RMSE performance of the reconstructed Extra Trees Regression model. It can be seen that the performance difference between the typical Extra Trees Regression model and the reconstructed Extra Trees Regression model is negligible.

Referring back to FIG. 2, as mentioned above, the estimation of the neighboring cells can be handled at the network device 110 without receiving the measurement information on the neighboring cells from the terminal device 120. In this way, the measurements on the neighboring cells and the transmission of the respective measurement reports are unnecessary at the terminal device 120. As such, the resources in the measurement gap and the resources for the transmission of the respective measurement reports can be reused.

In some embodiments, the network device 110 may transmit (225) first configuration information to the terminal device 120, the first configuration information disables a measurement gap for performing an inter-frequency carrier and inter-RAT carrier measurement. In turn, after receiving (225) the first configuration information, the terminal device 120 may disable the measurements on the neighboring cells. In this way, the inter-frequency measurements which cause the battery consuming can be avoided. As such, lower battery consuming and a green environment are advocated.

In addition or alternatively, the network device 110 may transmit (225) second configuration information to the terminal device 120, and the second configuration information indicates that a resource in the measurement gap is reused for receiving a transmission from the serving cell or transmitting a transmission to the serving cell. In turn, after receiving (225) the second configuration information, the terminal device 120 may reuse the resource in the measurement gaps to perform the data traffic. In this way, the throughput of the traffic for the terminal device 120 can be improved. In some cases, the gain of cell average throughput can be up to 30.7%, and there is almost no impact on other network KPI such as DR and HO SR observed. For purposes of illustration, the throughput gain is discussed with reference to FIGS. 6B-6D.

FIG. 6B illustrates the cell average throughput without the measurement gap according to some embodiments of the present disclosure. FIG. 6C illustrates the cell average throughput with the measurement gap according to some embodiments of the present disclosure. As shown in FIGS. 6B and 6C, without the measurement gap, the cell average throughput is improved relative to having the measurement gap.

FIGS. 6D and 6E illustrate the detailed gain value in different measurement gap configurations according to some embodiments of the present disclosure.

As shown in FIG. 6D, the blocks 610-1, 610-2 and 610-3 represent the minimum cell throughput, average cell throughput and the maximum throughput without the measurement gap, respectively. The blocks 620-1, 620-2 and 620-3 represent the minimum cell throughput, average cell throughput and the maximum throughput with the measurement gap, respectively. In this example, the gain of the average cell throughput is 30.7%, when the measurement gap is disabled or is reused for other purposes.

FIG. 6E illustrates the gain of resource block utilization according to some embodiments of the present disclosure. As shown in FIG. 6E, the block 630 represents the utilization rate of the physical resource blocks (PRB) for the physical uplink shared channel (PUSCH) with the measurement gap. The block 640 represents the utilization rate of the physical resource blocks (PRB) for the physical uplink shared channel (PUSCH) without the measurement gap. In this example, when the measurement gap is disabled or is reused for other purposes, the PRB for the PUSCH can be saved significantly.

In view of the above, with the embodiments in this disclosure, only RSPR and RSRQ associated with the serving cell and DOA of the terminal device are used as inputs for the ML or AI model. Moreover, the prediction accuracy of the ML or AI model can be up to 98.5%. In addition, the embodiments can be compatible with different ML or AI models, such as, Linear Regression, KNeighbors Regression, Random Forest Regression, Extra Trees Regression and DNN. Specifically, the Extra Trees Regression can be reconstructed to have better performance and lower complexity. The embodiments in this disclosure may be also easily used for other RAN level user scenarios such as load balance, handover, Scell selection and so on. Without any limitation, although the embodiments in the disclosure are provided in the new radio (NR), but the embodiments have the backward compatibility for LTE, 3G, 2G and inter-RAT network. Furthermore, the UL PRB resources consumption can be reduced, since the measurement reports are not needed any more, and the battery consumption for the inter-frequency and inter-RAT measurement can be reduced accordingly.

FIG. 7 shows a flowchart of an example method 700 implemented at a network device (for example, the network device 110) in accordance with some embodiments of the present disclosure. For the purpose of discussion, the method 700 will be described from the perspective of the network device 110 with reference to FIG. 1.

At 710, the network device 110 receives, from the terminal device 120, at least one of RSRP and RSRQ associated with a serving cell of the terminal device 120. At 720, the network device 110 determines, based on the at least one of the RSRP and the RSRQ associated with the serving cell, a signal quality level associated with a neighboring cell of the serving cell using a ML or AI model.

In some embodiments, the signal quality level associated with the neighboring cell is determined further based on a DOA of a signal transmitted from the terminal device 120 to the network device 110, and the DOA is calculated by the network device.

In some embodiments, the ML or AI model may comprise an extra tree regression model, a random forest regression model, a linear regression model, a KNeighborsRegressor model, or a DNN model.

In some embodiments, the ML or AI model comprises the extra tree regression model, and the network device 110 can further construct the extra tree regression model by training a plurality of trees based on a plurality of training data sets; and reconstruct the extra tree regression model by reducing a number of the plurality of trees within the extra tree regression model.

In some embodiments, the ML or AI model is trained based on historical data of at least one of RSRP and RSRQ measured by a plurality of terminal devices in respective serving cells.

In some embodiments, the network device 110 may further transmit, to the terminal device, first configuration information for disabling a measurement gap for performing an inter-frequency carrier and inter-radio RAT carrier measurement. Alternatively or additionally, the network device 110 may transmit, to the terminal device, second configuration information indicating that a resource in the measurement gap is reused for receiving a transmission from the serving cell or transmitting a transmission to the serving cell.

In some embodiments, the serving cell is configured with a first carrier frequency and a first RAT, and the neighboring cell is configured with at least one of: a second carrier frequency different from the first carrier frequency; or a second RAT different from the first RAT.

In some embodiments, the signal quality level associated with the neighboring cell comprises at least one of RSRP or RSRQ.

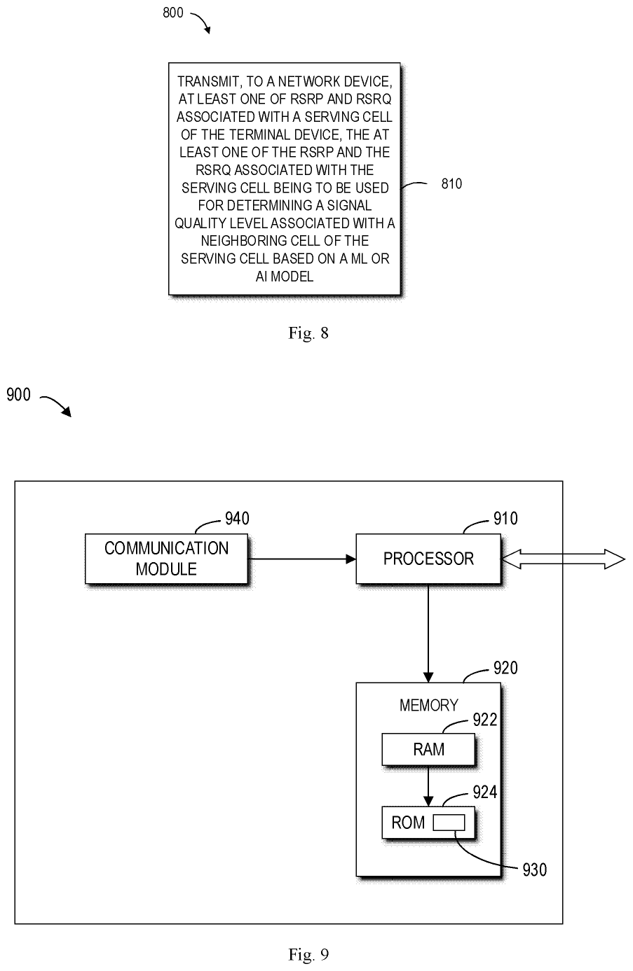

FIG. 8 shows a flowchart of an example method 800 implemented at a terminal device (for example, the terminal device 120) in accordance with some embodiments of the present disclosure. For the purpose of discussion, the method 800 will be described from the perspective of the terminal device 120 with reference to FIG. 1.

At 810, the terminal device 120 transmits at least one of RSRP and RSRQ associated with a serving cell of the terminal device to the network device 110. The at least one of the RSRP and the RSRQ associated with the serving cell is to be used for determining a signal quality level associated with a neighboring cell of the serving cell based on a ML or AI model.

In some embodiments, the signal quality level associated with the neighboring cell is determined further based on a DOA of a signal transmitted from the terminal device 120 to the network device 110. The DOA is calculated by the network device 110.

In some embodiments, the ML or AI model is trained based on historical data of at least one of RSRP and RSRQ measured by a plurality of terminal devices in respective serving cells.

In some embodiments, the ML or AI model comprises an extra tree regression model, a random forest regression model, a linear regression model, a KNeighborsRegressor model, or a DNN model.

In some embodiments, the terminal device 120 can further receive, from the network device 110, a first configuration information for disabling a measurement gap for performing an inter-frequency carrier and RAT carrier measurement; or receive, from the network device 110, a second configuration information indicating that a resource in the measurement gap is reused for receiving a transmission from the serving cell or transmitting a transmission to the serving cell.

In some embodiments, the serving cell is configured with a first frequency carrier and a first RAT, and the neighboring cell is configured with a second frequency carrier different from the first frequency carrier; or a second RAT different from the first RAT.

In some embodiments, the signal quality level associated with the neighboring cell comprises at least one of RSRP or RSRQ.

In some embodiments, an apparatus capable of performing any of operations of the method 700 (for example, the network device 110) may include means for receiving, from a terminal device 120, at least one of RSRP and RSRQ associated with a serving cell of the terminal device; and means for determining, based on the at least one of the RSRP and the RSRQ associated with the serving cell, a signal quality level associated with a neighboring cell of the serving cell using a ML or AI model.

In some embodiments, the signal quality level associated with the neighboring cell is determined further based on a DOA of a signal transmitted from the terminal device 120 to the network device 110, and the DOA is calculated by the network device.

In some embodiments, the ML or AI model comprises an extra tree regression model, a random forest regression model, a linear regression model, a KNeighborsRegressor model, or a DNN model.

In some embodiments, the ML or AI model comprises the extra tree regression model, and the network device 110 is further caused to: construct the extra tree regression model by training a plurality of trees based on a plurality of training data sets; and reconstruct the extra tree regression model by reducing a number of the plurality of trees within the extra tree regression model.

In some embodiments, the ML or AI model is trained based on historical data of at least one of RSRP and RSRQ measured by a plurality of terminal devices in respective serving cells.

In some embodiments, the apparatus further comprises: means for transmitting, to the terminal device, first configuration information for disabling a measurement gap for performing an inter-frequency carrier and inter-radio RAT carrier measurement; or means for transmitting, to the terminal device, second configuration information indicating that a resource in the measurement gap is reused for receiving a transmission from the serving cell or transmitting a transmission to the serving cell.

In some embodiments, the serving cell is configured with a first carrier frequency and a first RAT, and the neighboring cell is configured with at least one of: a second carrier frequency different from the first carrier frequency; or a second RAT different from the first RAT.

In some embodiments, the signal quality level associated with the neighboring cell comprises at least one of RSRP or RSRQ.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the terminal device 120) may include means for transmitting, to a network device, at least one of RSRP and RSRQ of a serving cell of the terminal device, and the at least one of the RSRP and the RSRQ of the serving cell being to be used for determining a signal quality level of a neighboring cell of the serving cell based on a ML or AI model.

In some embodiments, the signal quality level associated with the neighboring cell is determined further based on a DOA of a signal transmitted from the terminal device 120 to the network device 110, and the DOA is calculated by the network device 110.

In some embodiments, the ML or AI model is trained based on historical data of at least one of RSRP and RSRQ measured by a plurality of terminal devices in respective serving cells.

In some embodiments, the ML or AI model comprises one of: an extra tree regression model; a random forest regression model; a linear regression model; a KNeighborsRegressor model; or a DNN model.

In some embodiments, the apparatus further comprises at least one of: means for receiving, from the network device 110, a first configuration information for disabling a measurement gap for performing an inter-frequency carrier and inter-radio access technology (RAT) carrier measurement; or means for receiving, from the network device 110, a second configuration information indicating that a resource in the measurement gap is reused for receiving a transmission from the serving cell or transmitting a transmission to the serving cell.

In some embodiments, the serving cell is configured with a first frequency carrier and a first RAT, and the neighboring cell is configured with at least one of: a second frequency carrier different from the first frequency carrier; or a second RAT different from the first RAT.

In some embodiments, the signal quality level associated with the neighboring cell comprises at least one of RSRP or RSRQ.

In some embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

FIG. 9 is a simplified block diagram of a device 900 that is suitable for implementing embodiments of the present disclosure. The device 900 may be provided to implement the communication device, for example the network device 110 or the terminal device 120 as shown in FIG. 1. As shown, the device 900 includes one or more processors 910, one or more memories 940 coupled to the processor 910, and one or more transmitters and/or receivers (TX/RX) 940 coupled to the processor 910.

The TX/RX 940 is for bidirectional communications. The TX/RX 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a read only memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A program 930 includes executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program so that the device 900 may perform any process of the disclosure as discussed with reference to FIGS. 2 to 8. The embodiments of the present disclosure may also be implemented by hardware or by a combination of software and hardware.

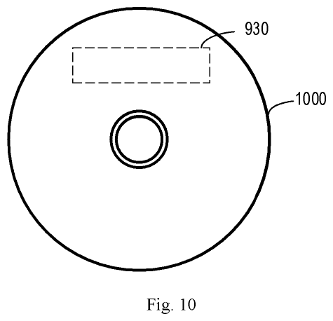

In some embodiments, the program 930 may be tangibly contained in a readable storage medium which may be included in the device 900 (such as in the memory 920) or other storage devices that are accessible by the device 900. The device 900 may load the program 930 from the storage medium to the RAM 922 for execution. The storage medium may include any types of tangible non-volatile storage, such as ROM, EPROM, a flash memory, a hard disk, CD, DVD, and the like. FIG. 10 shows an example of the storage medium 1000 in form of CD or DVD. The storage medium has the processor instructions 930 stored therein.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one program product tangibly stored on a non-transitory readable storage medium. The program product includes executable instructions, such as those included in program modules, being executed in a device on a target real or virtual processor, to carry out process 200, the method 700 or 800 as described above with reference to FIG. 2 to FIG. 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the program codes or related data may be carried by any suitable carrier to enable the device, apparatus or processor to perform various processes and operations as described above. Examples of the carrier include a signal, readable storage medium, and the like.

The readable medium may be a readable signal medium or a readable storage medium. A readable storage medium may include but not limited to an electronic, magnetic, optical, electromagnetic, infrared, or semiconductor system, apparatus, or device, or any suitable combination of the foregoing. More specific examples of the readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A network device, comprising:
at least one processor; and
at least one memory storing instructions that, when executed with the at least one processor, cause the network device at least to:
receive, from a terminal device, at least one of reference signal received power or reference signal received quality associated with a serving cell of the terminal device; and
determine, based on the at least one of the reference signal received power or the reference signal received quality associated with the serving cell, a signal quality level associated with a neighboring cell of the serving cell using a machine learning or artificial intelligence model.

2. The network device of claim 1, wherein the instructions, when executed with the at least one processor, further determine the signal quality level associated with the neighboring cell based on a direction of arrival of a signal transmitted from the terminal device to the network device, and wherein the direction of arrival is calculated with the network device.

3. The network device of claim 1, wherein the machine learning or artificial intelligence model comprises one of:
an extra tree regression model;
a random forest regression model;
a linear regression model;
a KNeighborsRegressor model; or
a deep neural network model.

4. The network device of claim 3, wherein the machine learning or artificial intelligence model comprises the extra tree regression model, and the instructions, when executed with the at least one processor, further cause the network device to:
construct the extra tree regression model with training a plurality of trees based on a plurality of training data sets; and
reconstruct the extra tree regression model with reducing a number of the plurality of trees within the extra tree regression model.

5. The network device of claim 1, wherein the instructions, when executed with the at least one processor, train the machine learning or artificial intelligence model based on historical data of at least one of reference signal received power or reference signal received quality measured with a plurality of terminal devices in respective serving cells.

6. The network device of claim 1, wherein the instructions, when executed with the at least one processor, further cause the network device to at least one of:
transmit, to the terminal device, first configuration information for disabling a measurement gap for performing an inter-frequency carrier and inter-radio access technology carrier measurement; or
transmit, to the terminal device, second configuration information indicating that a resource in the measurement gap is reused for receiving a transmission from the serving cell or transmitting a transmission to the serving cell.

7. The network device of claim 1, wherein the serving cell is configured with a first carrier frequency and a first radio access technology, and wherein the neighboring cell is configured with at least one of:
a second carrier frequency different from the first carrier frequency; or
a second radio access technology different from the first radio access technology.

8. The network device of claim 1, wherein the signal quality level associated with the neighboring cell comprises at least one of reference signal received power or reference signal received quality.

9. A terminal device, comprising:
at least one processor; and
at least one memory storing instructions that, when executed with the at least one processor, cause the terminal device at least to:
transmit, to a network device, at least one of reference signal received power or reference signal received quality associated with a serving cell of the terminal device,
the at least one of the reference signal received power or the reference signal received quality associated with the serving cell being to be used for determining a signal quality level associated with a neighboring cell of the serving cell based on a machine learning or artificial intelligence model.

10. The terminal device of claim 9, wherein the instructions, when executed with the at least one processor, further determine the signal quality level associated with the neighboring cell based on a direction of arrival of a signal transmitted from the terminal device to the network device, and wherein the direction of arrival is calculated with the network device.

11. The terminal device of claim 9, wherein the machine learning or artificial intelligence model is trained based on historical data of at least one of reference signal received power or reference signal received quality measured with a plurality of terminal devices in respective serving cells.

12. The terminal device of claim 9, wherein the instructions, when executed with the at least one processor, train the machine learning or artificial intelligence model based on the measurement information on the serving cell and wherein the machine learning or artificial intelligence model comprises one of:
an extra trees regression model;
a random forest regression model;
a linear regression model;
a KNeighborsRegressor model; or
a deep neural network model.

13. The terminal device of claim 9, wherein the instructions, when executed with the at least one processor, further cause the terminal device to perform at least one of:
receiving, from the network device, a first configuration information for disabling a measurement gap for performing an inter-frequency carrier and inter-radio access technology carrier measurement; or
receiving, from the network device, a second configuration information indicating that a resource in the measurement gap is reused for receiving a transmission from the serving cell or transmitting a transmission to the serving cell.

14. The terminal device of claim 9, wherein the serving cell is configured with a first frequency carrier and a first radio access technology, and wherein the neighboring cell is configured with at least one of:
a second frequency carrier different from the first frequency carrier; or
a second radio access technology different from the first radio access technology.

15. The terminal device of claim 9, wherein the signal quality level associated with the neighboring cell comprises at least one of reference signal received power or reference signal received quality.

16. A method, comprising:
receiving, at a network device from a terminal device, at least one of reference signal received power or reference signal received quality associated with a serving cell of the terminal device; and
determining, based on the at least one of the reference signal received power or the reference signal received quality associated with the serving cell, a signal quality level associated with a neighboring cell of the serving cell using a machine learning or artificial intelligence model.

17. (canceled)

18. (canceled)

19. (canceled)

20. A non-transitory program storage device readable with an apparatus, tangibly embodying a program of instructions executable with the apparatus for performing at least the method of claim 16.
